(19) United States
(12) Patent Application Publication
(10) Pub. No.: US 2025/0137658 A1
(43) Pub. Date: May 1, 2025

(54) DUAL-CHAMBER OVEN

(71) Applicant: NIDA IC VE DIS TIC A.S., ISTANBUL (TR)

(72) Inventor: MUSTAFA USTAOGLU, ISTANBUL (TR)

(73) Assignee: NIDA IC VE DIS TIC A.S., ISTANBUL (TR)

(21) Appl. No.: 18/495,010

(22) Filed: Oct. 26, 2023

(51) Int. Cl. F24C 15/02; A47J 37/06

(52) U.S. Cl. CPC F24C 15/023; A47J 37/0623

(57) ABSTRACT

The present invention relates to the technical field of ovens and discloses a dual-chamber oven with multiple door opening modes, including an oven body and a door, where one end of the door may move radially along the oven body, making the door keep away from an opening structure of the oven body; and the door includes at least a first door and a second door that may be movably assembled on the door, and one end of the first door and one end of the second door may move radially along the door, making the first door and the second door keep away from the door.

### TECHNICAL FIELD

The present invention relates to the technical field of ovens, and more specifically, to a dual-chamber oven.

### BACKGROUND

Ovens are commonly used electrical appliances in daily life. Most of conventional dual-chamber ovens on the current market have a single door to be separately opened or closed. In the above opening or closing mode, when the time for placing food baked in two independent chambers or the time for food that needs to be baked is inconsistent, the door is opened separately, such that the chamber whose baking time is not reached is also opened to cause dissipation of heat in the chamber, which is not conducive to baking the food, thus affecting usage experience of users.

Therefore, how to design a door opening mechanism capable of implementing separate or simultaneous opening has become a technical problem to be urgently solved by those skilled in the art.

### SUMMARY

For the technical problem that most of conventional dual-chamber ovens on the current market in the prior art have a single door to be separately opened or closed and thus are simplex in door opening mode, the present invention provides a dual-chamber oven with multiple door opening modes.

To solve the technical problem, the present invention adopts the following technical solution: a dual-chamber oven is constructed, including:
an oven body set to be provided with an opening structure at a front end, where the oven body is formed into a hollow structure; and
a door movably arranged in the opening structure of the oven body and configured to cover the opening structure of the oven body, where
one end of the door is capable of moving radially along the oven body, making the door keep away from the opening structure of the oven body,
the door includes at least a first door and a second door,
the first door and the second door are movably assembled on the door, and
one end of the first door and one end of the second door are capable of moving radially along the door, making the first door and the second door keep away from the door.

In some embodiments, when a left side or a right side of the first door is unlocked, one end of the first door is capable of moving radially along the door, making the first door keep away from the door, and/or
when a left side and a right side of the first door are unlocked, one end of the first door is capable of moving radially along the door, making the first door keep away from the door; and
when a left side or a right side of the second door is unlocked, one end of the second door is capable of moving radially along the door, making the second door keep away from the door, and/or
when a left side and a right side of the second door are unlocked, one end of the second door is capable of moving radially along the door, making the second door keep away from the door.

In some embodiments, first openings and second openings are provided on the door,
the first door is movably assembled in the first openings of the door, and
the second door is movably assembled in the second openings of the door.

In some embodiments, the first door is provided with an opening or closing assembly, a transmission assembly, and locking assemblies,
the opening or closing assembly is arranged at a front end of the first door,
one end of the transmission assembly abuts against one end of the opening or closing assembly,
the other end of the transmission assembly abuts against one end of each of the locking assemblies, and
the other end of each of the locking assemblies is embedded into the door.

In some embodiments, the door includes a first frame and a second frame,
the first frame is attached to the second frame, and
a first square through hole and a second square through hole arranged symmetrically are provided on an inner side of the first opening of the first frame.

In some embodiments, each of the locking assemblies includes a first locking element, a second locking element, a first covering element, and a second covering element,
the first covering element and the second covering element are arranged in an inner chamber of the first door,
the first locking element is arranged in the first covering element, and one end of the first locking element abuts against a limit clamping groove of the first covering element.
the other end of the first locking element penetrates through an opening of the first covering element and extends into the first square through hole of the first frame.
the second locking element is arranged in the second covering element, and one end of the second locking element abuts against a limit clamping groove of the second covering element, and
the other end of the second locking element penetrates through an opening of the second covering element and extends into the second square through hole of the first frame.

In some embodiments, one end of the first locking element is provided with an arc-shaped extension portion, an opposite side of the arc-shaped extension portion is provided with a cylinder, a first limit spring element is nested in the cylinder,
a middle section of the first locking element is provided with a first bulge, one side of the first bulge is provided with a first inclined surface,
the cylinder and the first limit spring element of the first locking element abut against the limit clamping groove of the first covering element, and
the arc-shaped extension portion of the first locking element penetrates through the opening of the first covering element and extends into the first square through hole of the first frame.

In some embodiments, one end of the second locking element is provided with an arc-shaped extension portion, an opposite side of the arc-shaped extension portion is provided with a cylinder, a second limit spring element is nested in the cylinder,
a middle section of the second locking element is provided with a second bulge, one side of the second bulge is provided with a second inclined surface,
the cylinder and the second limit spring element of the second locking element abut against the limit clamping groove of the second covering element, and
the arc-shaped extension portion of the second locking element penetrates through the opening of the second covering element and extends into the second square through hole of the first frame.

In some embodiments, the transmission assembly includes a receiving component, a transmission rod, a first adapter component, a first reset spring element, a second adapter component, and a second reset spring element.
one end of the receiving component abuts against one end of the transmission rod and one end of the first adapter component,
the other end of the transmission rod abuts against one end of the second adapter component,
the first reset spring element is sleeved at the other end of the first adapter component,
the second reset spring element is sleeved at the other end of the second adapter component,
the other end of the first adapter component abuts against the first inclined surface of the first bulge, and
the other end of the second adapter component abuts against the second inclined surface of the second bulge.

In some embodiments, one end of the transmission rod is provided with a circular structure, the other end of the transmission rod is provided with a connecting piece,
the circular structure at one end of the transmission rod abuts against one end of the receiving component, and
the connecting piece at the other end of the transmission rod abuts against one end of the second adapter component.

In some embodiments, one end of the first adapter component is provided with a cylinder extending outwards,
the other end of the first adapter component is provided with a third inclined surface,
a middle section of the first adapter component is provided with a limit ring,
one end of the first reset spring element is sleeved at one end of the third inclined surface of the first adapter component and limited by the limit ring,
the cylinder of the first adapter component abuts against one end of the receiving component, and
the third inclined surface of the first adapter component abuts against the first inclined surface.

In some embodiments, one end of the second adapter component is provided with a cylinder extending outwards,
the other end of the second adapter component is provided with a fourth inclined surface,
a middle section of the second adapter component is provided with a limit ring,
one end of the second reset spring element is sleeved at one end of the fourth inclined surface of the second adapter component and limited by the limit ring.
the cylinder of the second adapter component abuts against one end of the connecting piece at the other end of the transmission rod, and
the fourth inclined surface of the second adapter component abuts against the second inclined surface.

In some embodiments, one end surface of the receiving component is provided with a recess, a third bulge is arranged on an adjacent side of the recess,
the recess of the receiving component is detachably connected to one end of the opening or closing component, and
the third bulge of the receiving component abuts against the circular structure at one end of the transmission rod and the cylinder of the first adapter component.

In some embodiments, one side of the opening or closing component is provided with an arc bulge, an opposite side of the are bulge is provided with a raised connecting rod, and
the raised connecting rod is embedded into the recess of the receiving component.

In some embodiments, the first door further includes a front cover plate and a rear cover plate,
and the front cover plate is detachably connected to the rear cover plate.

In some embodiments, a third square through hole and a fourth square through hole arranged symmetrically are provided on a left side and a right side of an upper end of the rear cover plate,
the third square through hole is coaxial with the first square through hole, and
the fourth square through hole is coaxial with the second square through hole.

In some embodiments, the rear cover plate is set to be of a hollow structure, the hollow structure is set as an annular hollow groove, and
the groove is configured to place the first locking element, the second locking element, the first covering element, and the second covering element.

In some embodiments, a limit component is arranged at one end of the oven body and one end of the door, and
the limit component is configured to limit an opening or closing angle of the door when moving radially along the oven body.

The dual-chamber oven according to the present invention includes the oven body and the door, where one end of the door may move radially along the oven body, making the door keep away from the opening structure of the oven body; and the door includes at least the first door and the second door that may be movably assembled on the door, and one end of the first door and one end of the second door may move radially along the door, making the first door and the second door keep away from the door. Compared with the prior art, the door opening modes of the dual-chamber oven are added, making combination of dual-chamber ovens convenient and practical, thereby overcoming the defect that most of conventional dual-chamber ovens have a single door to be separately opened or closed and thus are simplex in door opening mode.

### BRIEF DESCRIPTION OF DRAWINGS

The present invention is further described below with reference to the accompanying drawings and embodiments. In the drawings:

FIG. 1 is a three-dimensional view of an embodiment of a dual-chamber oven provided by the present invention;

FIG. 2 is a three-dimensional view of another embodiment of a dual-chamber oven provided by the present invention;

FIG. 3 is a three-dimensional view of yet another embodiment of a dual-chamber oven provided by the present invention;

FIG. 4 is a side view of an embodiment of a dual-chamber oven provided by the present invention;

FIG. 5 is an exploded view of an embodiment of a dual-chamber oven provided by the present invention;

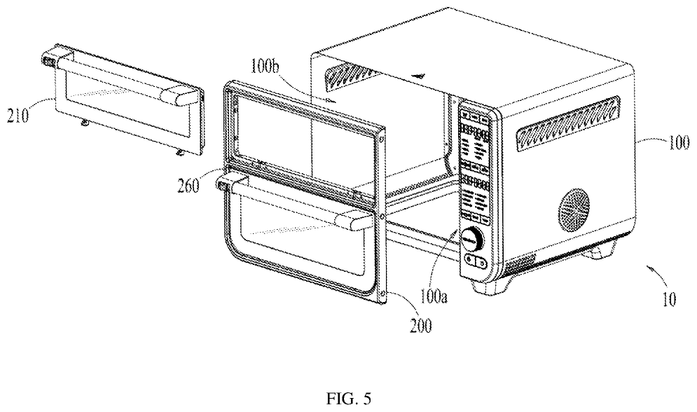

FIG. 6 is an exploded view of an embodiment of a door provided by the present invention;

FIG. 7 is an exploded view of an embodiment of a first door provided by the present invention;

FIG. 8A is an exploded view of an embodiment of a first door or a second door body provided by the present invention;

FIG. 8B is a schematic action diagram of an embodiment of a first door or a second door body provided by the present invention;

FIG. 9 is a three-dimensional view of an embodiment of an opening or closing assembly, a transmission assembly, and locking assemblies provided by the present invention;

FIG. 10 is a three-dimensional view of an embodiment of a first locking element or a second locking element provided by the present invention;

FIG. 11 is a three-dimensional view of an embodiment of a first frame provided by the present invention;

FIG. 12 is a three-dimensional view of an embodiment of an opening or closing assembly provided by the present invention;

FIG. 13 is a schematic enlarged view of A in FIG. 6;

FIG. 14 is a schematic enlarged view of B in FIG. 6;

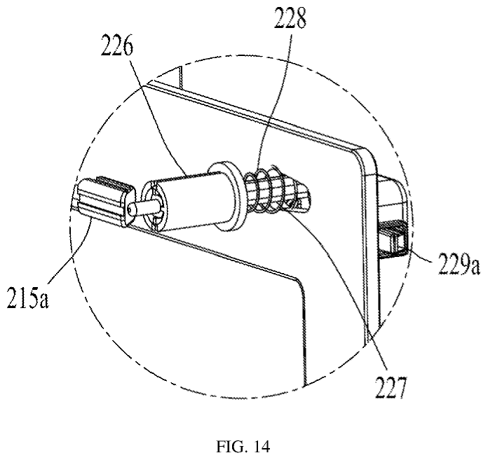

FIG. 15 is a schematic enlarged view of C in FIG. 7;

FIG. 16 is a schematic enlarged view of D in FIG. 7; and

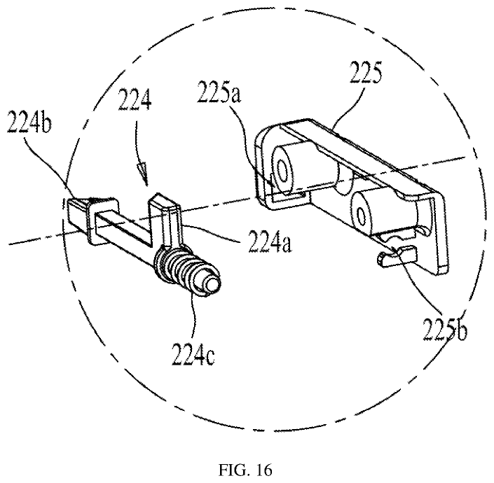

FIG. 17 is a schematic enlarged view of E in FIG. 7.

### DETAILED DESCRIPTION OF THE EMBODIMENTS

To understand the technical features, objective, and effects of the present invention more clearly, specific embodiments of the present invention are now described in detail with reference to the accompanying drawings.

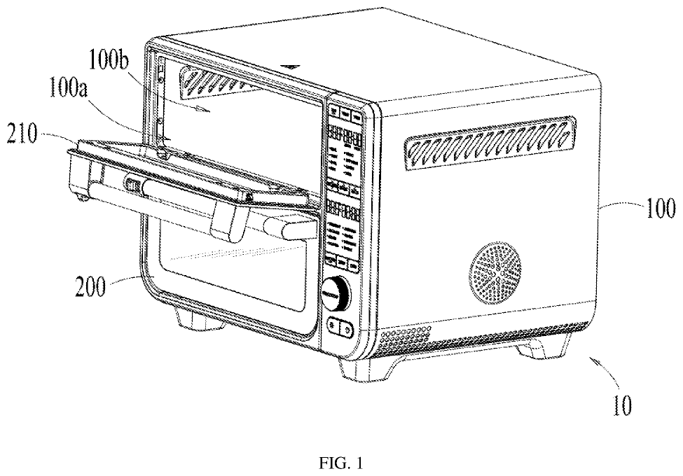

As shown in FIG. 1 to FIG. 4, in a first embodiment of a dual-chamber oven according to the present invention, the dual-chamber oven 10 includes an oven body 100 and a door 200.

The oven body 100 is of a square structure and is configured to bear food to be baked or heated.

The door 200 is of a square structure and is detachably arranged in an opening structure 100a at a front end of the oven body 100.

Specifically, the oven body 100 is set to be provided with the opening structure 100a at the front end and is formed into a hollow structure 100b.

The door 200 is movably arranged in the opening structure 100a of the oven body 100 and configured to cover the opening structure 100a of the oven body 100,
where one end of the door 200 may move radially along a lower end of the oven body 100, making the door 200 keep away from the opening structure 100a of the oven body 100 to open or close the oven body 100.

The door 200 includes at least a first door 210 and a second door 260.

The first door 210 is movably assembled at an upper end of the door 200, and the second door 260 is movably assembled at a lower end of the door 200 and is adjacent to the first door 210, where
one end of the first door 210 and one end of the second door 260 are capable of moving radially along a bottom side of the door 200, making the first door 210 and the second door 260 keep away from the door 200 to open or close the oven body 100.

Opening modes of the oven body may be as follows:

As shown in FIG. 1, the first door 210 moves radially along a bottom side of a middle section of a frame of the door 200, and the second door 260 and the door 200 are in a closed state, making the first door 210 keep away from the door 200, and the first door and the door may form an opening or closing angle of 0-90°.

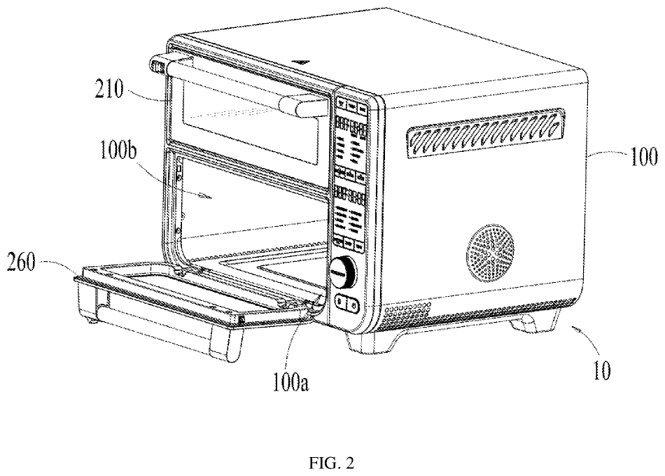

As shown in FIG. 2, the second door 260 moves radially along a bottom side of the frame of the door 200, and the first door 210 and the door 200 are in a closed state, making the second door 260 keep away from the door 200, and the second door and the door may form an opening or closing angle of 0-90°.

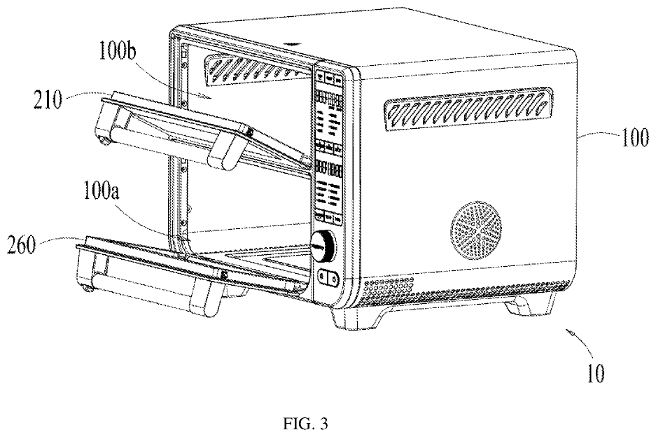

As shown in FIG. 3, the first door 210 and the second door 260 move radially along the middle section and the bottom side of the frame of the door 200, making the first door 210 and the second door 260 keep away from the door 200, and the first door 210 and the second door 260 may form an opening or closing angle of 0-90° with the door 200.

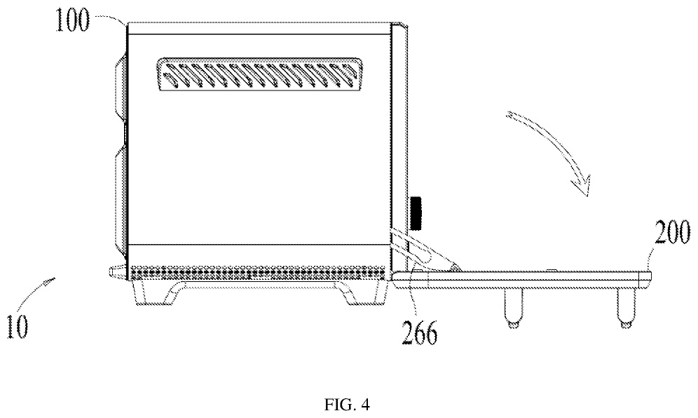

As shown in FIG. 4, the first door 210 and the second door 260 are in a closed state, and the lower end of the door 200 may move radially along the lower end of the oven body 100, making the door 200 keep away from the opening structure 100a of the oven body 100 to open or close the oven body 100, and the door 200 may form an opening or closing angle of 0-90° with the oven body 100.

With the technical solution, the door opening modes of the dual-chamber oven are added, making combination of dual-chamber ovens convenient and practical, thereby solving the problem that most of conventional dual-chamber ovens have a single door to be separately opened or closed and thus are simplex in door opening mode.

In some embodiments, as shown in FIGS. 1 to 4 and FIG. 8a, when a left side or a right side of the first door 210 is unlocked, one end of the first door 210 is capable of moving radially along the door 200, making the first door 210 keep away from the door 200, and/or

when a left side and a right side of the first door 210 are unlocked, one end of the first door 210 is capable of moving radially along the door 200, making the first door 210 keep away from the door 200; and

it may be understood that when the left side or the right side of the first door 210 is unlocked, the first door 210 is capable of keeping away from the door 200 to be opened, and

when both the left side and the right side of the first door 210 are unlocked, the first door 210 is capable of keeping away from the door 200.

When a left side or a right side of the second door 260 is unlocked, one end of the second door 260 is capable of moving radially along the door 200, making the second door 260 keep away from the door 200, and/or

when a left side and a right side of the second door 260 are unlocked, one end of the second door 260 is capable of moving radially along the door 200, making the second door 260 keep away from the door 200.

It may be understood that when the left side or the right side of the second door 260 is unlocked, the second door 260 is capable of keeping away from the door 200 to be opened, and

when both the left side and the right side of the second door 260 are unlocked, the second door 260 is capable of keeping away from the door 200.

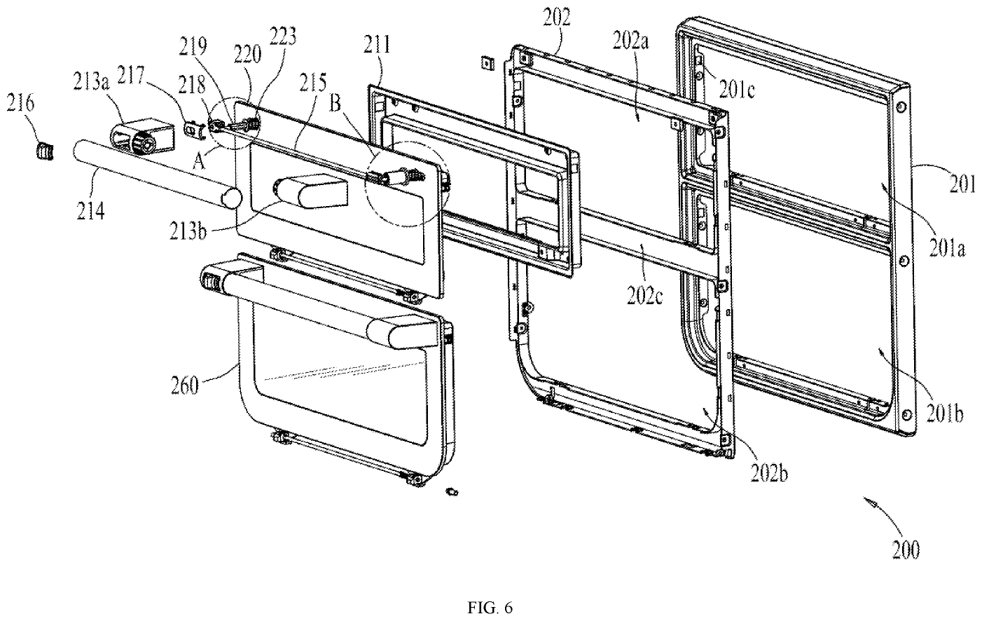

In some embodiments, as shown in FIG. 6, first openings (201a and 202a) and second openings (201b and 202b) are provided on the door 200,
where the first door 210 is movably assembled in the first openings (201a and 202a) of the door 200, and a lower end of the first door 210 is capable of moving radially along lower ends of the first openings (201a and 202a) of the door 200, making an upper end of the first door 210 separate from the first openings (201a and 202a); and
the second door 260 is movably assembled in the second openings (201b and 202b) of the door 200, and a lower end of the second door 260 is capable of moving radially along lower ends of the second openings (201b and 202b) of the door 200, making an upper end of the second door 260 separate from the second openings (201b and 202b).

It should be noted that the second door 260 and the first door 210 are consistent in structure and action, and the first door 210 will be discussed later.

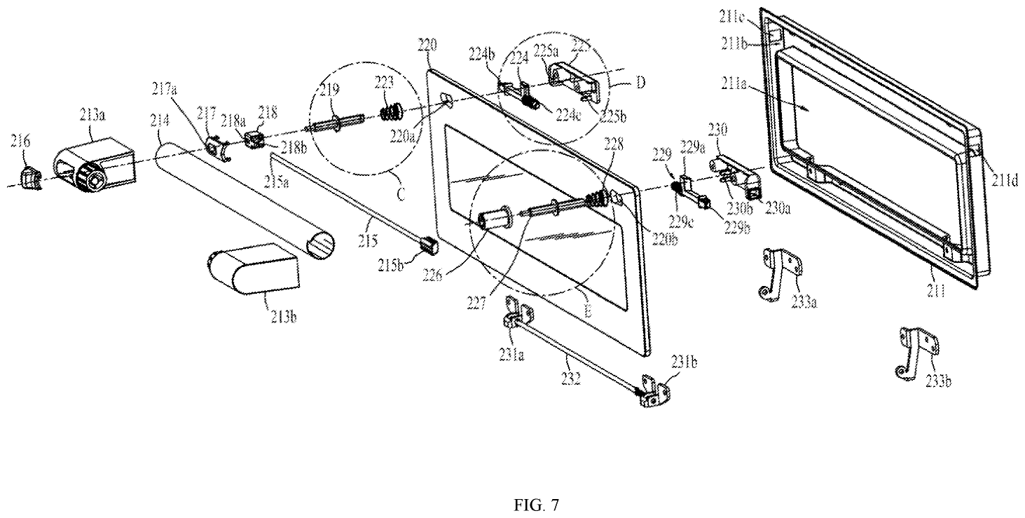

In some embodiments, as shown in FIG. 7, the first door 210 is provided with an opening or closing assembly 216, a transmission assembly, and multiple locking assemblies,
where the opening or closing assembly 216 is configured to apply a transverse torque to the transmission assembly;
the transmission assembly is configured to receive the transverse torque applied by the opening or closing assembly 216 and apply the transverse torque to the locking assemblies, causing the locking assemblies on left and right sides to retract inwards; and
the locking assemblies on the left and right sides are configured to lock the first door 210 or the second door 260 onto the door 200.

Specifically, the opening or closing assembly 216 is arranged at a front end of the first door 210 and configured to receive the transverse torque applied by a user;

one end of the transmission assembly abuts against one end of the opening or closing assembly 216 to receive the transverse torque and apply it to the locking assemblies;
the other end of the transmission assembly abuts against one end of each of the locking assemblies; and
the other end of each of the locking assemblies on the left and right sides is embedded into the door 200.

In some embodiments, as shown in FIG. 6, the door 200 includes a first frame 201 and a second frame 202, where the first frame 201 and the second frame 202 are hollowed out and configured to mount the first door 210 and the second door 260.

Specifically, the first frame 201 is attached to the second frame 202.

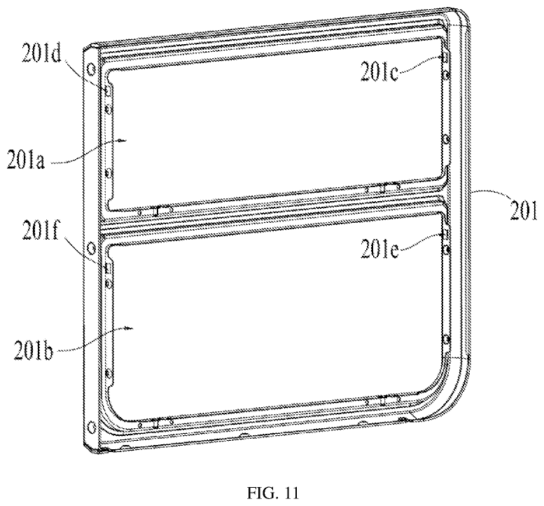

As shown in FIG. 11, a first square through hole 201c and a second square through hole 201d arranged symmetrically are provided on an inner side of the first opening 201a of the first frame 201, where one ends of the locking assemblies on the left and right sides of the upper end are embedded into the first square through hole 201c and the second square through hole 201d of the door 200, respectively, causing the first door 210 to be locked in the first opening 201a of the first frame 201; and

a fifth square through hole 201f and a sixth square through hole 201e arranged symmetrically are provided on an inner side of the second opening 202b of the first frame 201, where one ends of the locking assemblies on the left and right sides of the lower end are embedded into the fifth square through hole 201f and the sixth square through hole 201e of the door 200, respectively, causing the second door 260 to be locked in the second opening 201b of the first frame 201.

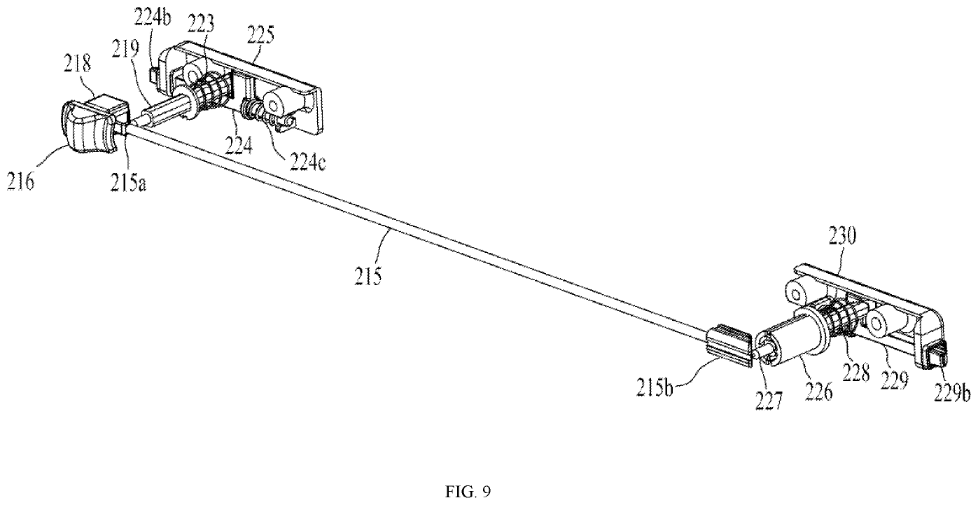

In some embodiments, as shown in FIG. 7, each of the locking assemblies includes a first locking element 224, a second locking element 229, a first covering element 225, and a second covering element 230,
where the first covering element 225 and the second covering element 230 are detachably arranged in an inner chamber 211b of the first door 210; and
the first locking element 224 is detachably arranged in the first covering element 225, where the first locking element 224 is radially arranged in the first covering element 225. As shown in FIG. 9, one end 224d of the first locking element 224 abuts against a limit clamping groove 225b of the first covering element 225;
the other end 224b of the first locking element 224 penetrates through an opening 225a of the first covering element 225 and extends into the first square through hole 201c of the first frame 201; and
the second locking element 229 is detachably arranged in the second covering element 230, where the second locking element 229 is radially arranged in the second covering element 230.

As shown in FIG. 9, one end 229d of the second locking element 229 abuts against a limit clamping groove 230b of the second covering element 230, and
the other end 229b of the second locking element 229 penetrates through an opening 230a of the second covering element 230 and extends into the second square through hole 201d of the first frame 201.

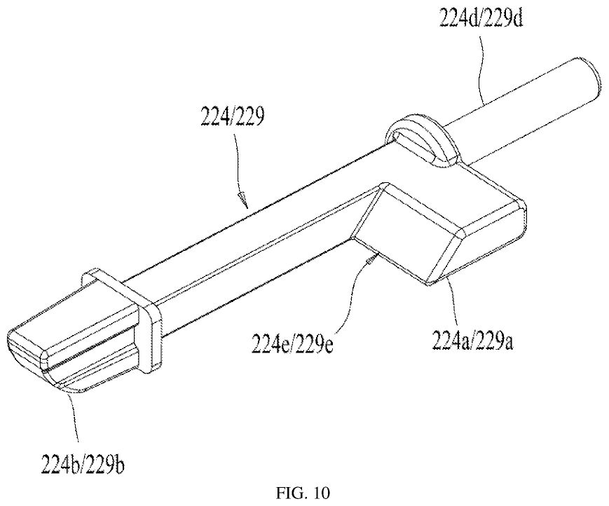

In some embodiments, as shown in FIG. 10, one end of the first locking element 224 is provided with an arc-shaped extension portion 224b, an opposite side of the arc-shaped extension portion 224b is provided with a cylinder 224d, a first limit spring element 224c is nested in the cylinder 224d,
a middle section of the first locking element 224 is provided with a first bulge 224a, one side of the first bulge 224a is provided with a first inclined surface 224e,
the cylinder 224d and the first limit spring element 224c of the first locking element 224 abut against the limit clamping groove 225b of the first covering element 225, and
the arc-shaped extension portion 224b of the first locking element 224 penetrates through the opening 225a of the first covering element 225 and extends into the first square through hole 201c of the first frame 201.

In some embodiments, as shown in FIG. 10, one end of the second locking element 229 is provided with an arc-shaped extension portion 229b, an opposite side of the arc-shaped extension portion 229b is provided with a cylinder 229d, a second limit spring element 229c is nested in the cylinder 229d,
a middle section of the second locking element 229 is provided with a second bulge 229a, one side of the second bulge 229a is provided with a second inclined surface 229e, the cylinder 229d and the second limit spring element 229c of the second locking element 229 abut against the limit clamping groove 230b of the second covering element 230, and
the arc-shaped extension portion 229b of the second locking element 229 penetrates through the opening 230a of the second covering element 230 and extends into the second square through hole 201d of the first frame 201.

In some embodiments, as shown in FIG. 7 and FIG. 9, the transmission assembly includes a receiving component 218, a transmission rod 215, a first adapter component 219, a first reset spring element 223, a second adapter component 227, and a second reset spring element 228,
where the receiving component 218 is configured to receive the transverse torque applied by the opening or closing assembly 216, and
one end 218b of the receiving component 218 abuts against one end 215a of the transmission rod 215.

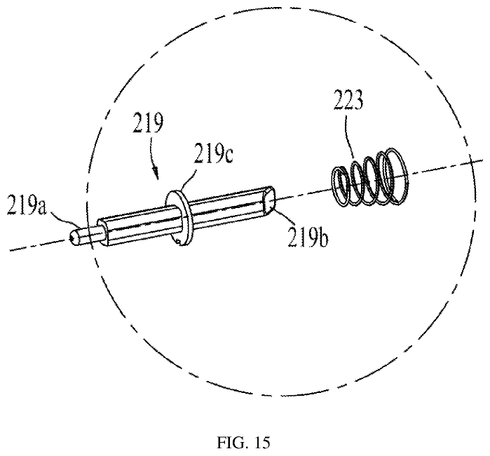

As shown in FIG. 15, one end 218b of the receiving component 218 further abuts against one end 219a of the first adapter component 219, and the transverse torque is applied to the transmission rod 215 and the first adapter component 219.

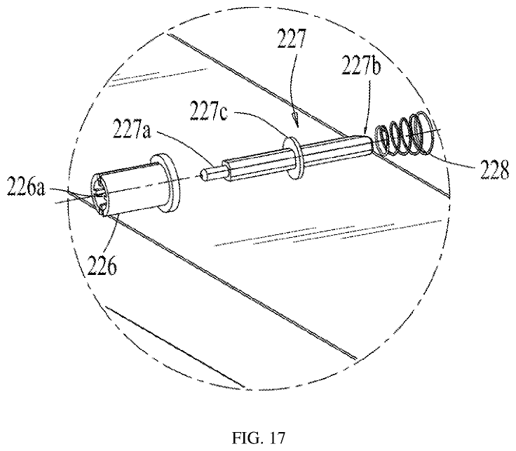

As shown in FIG. 17, the other end 215b of the transmission rod 215 abuts against one end 227a of the second adapter component 227,
the first reset spring element 223 is sleeved at the other end 219b of the first adapter component 219,
the second reset spring element 228 is sleeved at the other end 227b of the second adapter component 227,
the other end 219b of the first adapter component 219 abuts against the first inclined surface 224e of the first bulge 224a, and
the other end 227b of the second adapter component 227 abuts against the second inclined surface 229e of the second bulge 229a.

In some embodiments, as shown in FIG. 7 and FIG. 9, one end of the transmission rod 215 is provided with a circular structure 215a, the other end of the transmission rod is provided with a connecting piece 215b, the circular structure 215a at one end of the transmission rod 215 abuts against one end of the receiving component 218 to receive the transverse torque applied by the receiving component 218, and

The connecting piece 215b at the other end of the transmission rod 215 abuts against one end 227a of the second adapter component 227 to apply the transverse torque to the second adapter component 227.

In some embodiments, as shown in FIG. 15, one end of the first adapter component 219 is provided with a cylinder 219d extending outwards,
the other end of the first adapter component 219 is provided with a third inclined surface 219b,
a middle section of the first adapter component 219 is provided with a limit ring 219c,
one end of the first reset spring element 223 is sleeved at one end of the third inclined surface 219b of the first adapter component 219 and limited by the limit ring 219c, and
the cylinder 219d at one end of the first adapter component 219 abuts against one end of the receiving component 218 to receive the transverse torque applied by the receiving component 218.

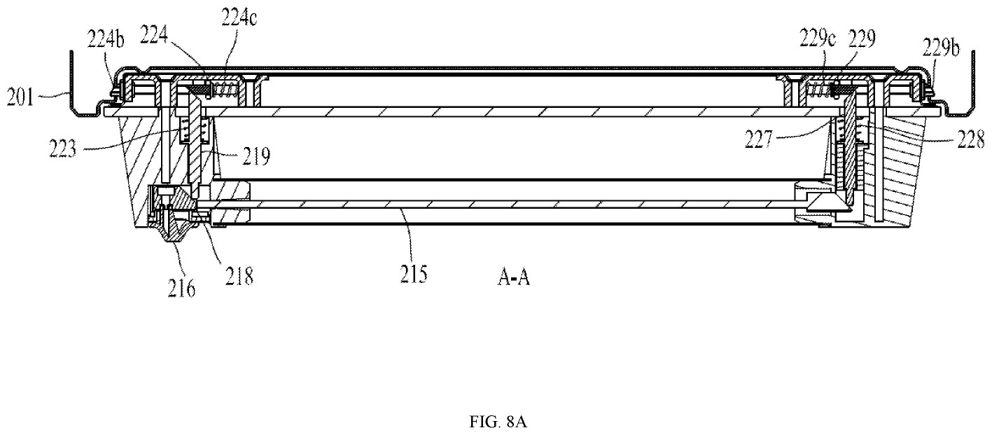

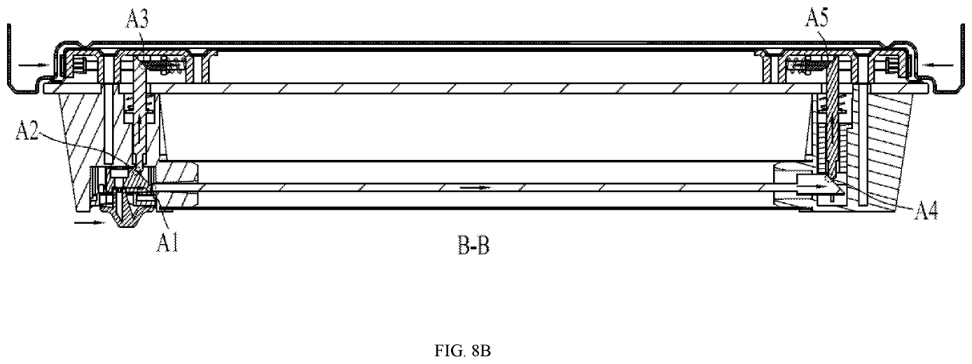

As shown in A3 in FIG. 8b, the third inclined surface 219b of the first adapter component 219 abuts against the first inclined surface 224e. When the third inclined surface 219b of the first adapter component 219 moves down, the arc-shaped extension portion 224b of the first locking element 224 is moved right to separate from the first square through hole 201c of the door 200.

In some embodiments, as shown in FIG. 17, one end of the second adapter component 227 is provided with a cylinder 227a extending outwards,
the other end of the second adapter component 227 is provided with a fourth inclined surface 227b,
a middle section of the second adapter component 227 is provided with a limit ring 227c,
one end of the second reset spring element 228 is sleeved at one end of the fourth inclined surface 227b of the second adapter component 227 and limited by the limit ring 227c.
the cylinder 227a of the second adapter component 227 abuts against one end of the connecting piece 215b at the other end of the transmission rod 215 to receive the transverse torque applied by the receiving component 218, and
the fourth inclined surface 227b of the second adapter component 227 abuts against the second inclined surface 229e.

The second adapter component 227 is sleeved with a guide component 226, the guide component 226 is set to be of a penetrating structure 226a, and the cylinder 227a of the second adapter component 227 penetrates through the penetrating structure 226a of the guide component 226 and abuts against one end of the connecting piece 215b at the other end of the transmission rod 215.

As shown in A4 and A5 in FIG. 8b, the connecting piece 215b of the transmission rod 215 abuts against one end 227a of the second adapter component 227, making the fourth inclined surface 227b of the second adapter component 227 abut against the second inclined surface 229e. When the fourth inclined surface 227b of the second adapter component 227 moves down, the arc-shaped extension portion 229b of the second locking element 229 is moved left to separate from the second square through hole 201d of the door 200.

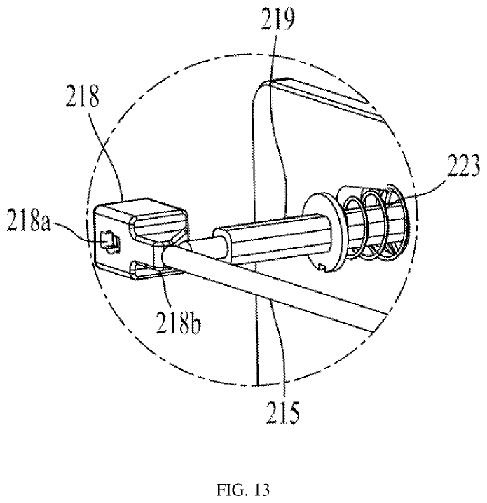

In some embodiments, as shown in FIG. 13, one end surface of the receiving component 218 is provided with a recess 218a, a third bulge 218b is arranged on an adjacent side of the recess 218a, the recess 218a of the receiving component 218 is detachably connected to one end of
the opening or closing component 216, and
the third bulge 218b of the receiving component 218 abuts against the circular structure 215a at one end of the transmission rod 215 and the cylinder 219d of the first adapter component 219.

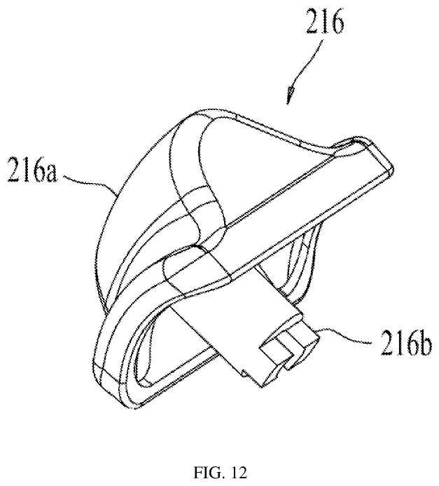

In some embodiments, as shown in FIG. 12, one side of the opening or closing component 216 is provided with an arc bulge 216a, an opposite side of the are bulge 216a is provided with a raised connecting rod 216b, and
the raised connecting rod 216b is embedded into the recess 218a of the receiving component 218.

In some embodiments, as shown in FIG. 7, the first door 210 further includes a front cover plate 220 and a rear cover plate 211, and the front cover plate 220 is detachably connected to the rear cover plate 211.

Further, a third square through hole 211c and a fourth square through hole 211d arranged symmetrically are provided on a left side and a right side of an upper end of the rear cover plate 211,
the third square through hole 211c is coaxial with the first square through hole 201e, and
the fourth square through hole 211d is coaxial with the second square through hole 201d.

A first fixing portion 233a and a second fixing portion 233b are fixedly arranged at a lower end of the rear cover plate 211, a first limit portion 231a and a second limit portion 231b are arranged on the first fixing portion 233a and the second fixing portion 233b, respectively, and a transverse rod 232 is arranged between the first limit portion 231a and the second limit portion 231b.

Further, a first through hole 220a and a second through hole 220b are provided on a left side and a right side of an upper end of a front side of the front cover plate 220, where the end of the first adapter component 219 that is not sleeved with the first reset spring element 223 abuts against the third bulge 218b of the receiving component 218 via the first through hole 220a; and
the end of the second adapter component 227 that is not sleeved with the second reset spring element 228 abuts against the connecting piece 215b of the transmission rod 215 via the second through hole 220b.

Further, a first positioning portion 213a and a second positioning portion 213b are further arranged on the front side of the front cover plate 220, and a handle part 214 is mounted between the first positioning portion 213a and the second positioning portion 213b, where the transmission rod 215 is nested in the handle part 214; and
the opening or closing assembly 216 is mounted on the first positioning portion 213a, and the raised connecting rod 216b of the opening or closing assembly 216 is embedded into the recess 218a of the receiving component 218 via a through hole 217a of a support member 217.

Further, the rear cover plate 211 is set to be of a hollow structure 211a, the hollow structure 211a is set as an annular hollow groove 211b, and
the groove 211b is configured to place the first locking element 224, the second locking element 229, the first covering element 225, and the second covering element 230.

In some embodiments, as shown in FIG. 4, a limit component 266 is arranged at one end of the oven body 100 and one end of the door 200, where one end of the limit component 266 is arranged in a chamber of the oven body 100, the other end of the limit component 266 is arranged on an inner edge of the door 200, and
the limit component 260 is configured to limit an opening or closing angle of the door when moving radially along the oven body 100.

An opening or closing state of the door is as follows:

As shown in FIG. 8a and FIG. 8b,
in an unlocking state;
as shown in A1 and A2 in FIG. 8b, when the opening or closing assembly 216 slides right, the receiving component 218 is driven to push the transmission rod 215 to move right and to push the first adapter component 219 to move down;
the first adapter component 219 moves down to push the first adapter component 219 to move down;
the transmission rod 215 moves right to push the second adapter component 227 to move down;
moreover, the first adapter component 219 pushes the first inclined surface 224e of the first locking element 224 to move right, making the arc-shaped extension portion 224b of the first locking element 224 retract inwards to separate from the first square through hole 201c;
the second adapter component 227 pushes the second inclined surface 229e of the second locking element 229 to move left, making the arc-shaped extension portion 229b of the second locking element 229 retract inwards to separate from the second square through hole 201d; and
the first locking element 224 and the second locking element 229 separate from the first frame 201 during inward retraction to complete unlocking, such that the first door 210 of the oven may be opened,
It should be noted that the second door 260 and the first door 210 are consistent in action, which will not be repeated herein.

In a reset state:
after the opening or closing assembly 216 is released, the first locking element 224 and the second locking element 229 are respectively reset by the first limit spring element 224c and the second limit spring element 229c and respectively move right and left, and the first adapter component 219 and the second adapter component 227 are pushed to move up.

In this case, the first reset spring element 223 and the second reset spring element 228 are reset. When the second adapter component 227 moves up, the transmission rod 215 is pushed to move left, and an upward thrust of the transmission rod 215 and a leftward thrust of the first adapter component 219 force the opening or closing assembly 216 and the receiving component 218 to move left to be reset.

The embodiments of the present invention have been described above in conjunction with the accompanying drawings, but the present invention is not limited to the above specific embodiments. The above specific embodiments are only schematic and not restrictive. Under the inspiration of the present invention, those of ordinary skill in the art may also make many forms without departing from the scope of protection of the objective and claims of the present invention, all of which fall within the scope of protection of the present invention.

What is claimed is:

1. A dual-chamber oven, comprising:
an oven body set to be provided with an opening structure at a front end, where the oven body is formed into a hollow structure; and
a door movably arranged in the opening structure of the oven body and configured to cover the opening structure of the oven body, wherein
one end of the door is capable of moving radially along the oven body, making the door keep away from the opening structure of the oven body,
the door comprises at least a first door and a second door,
the first door and the second door are movably assembled on the door, and
one end of the first door and one end of the second door are capable of moving radially along the door, making the first door and the second door keep away from the door.

2. The dual-chamber oven according to claim 1, wherein
when a left side or a right side of the first door is unlocked, one end of the first door is capable of moving radially along the door, making the first door keep away from the door, and/or
when a left side and a right side of the first door are unlocked, one end of the first door is capable of moving radially along the door, making the first door keep away from the door; and
when a left side or a right side of the second door is unlocked, one end of the second door is capable of moving radially along the door, making the second door keep away from the door, and/or
when a left side and a right side of the second door are unlocked, one end of the second door is capable of moving radially along the door, making the second door keep away from the door.

3. The dual-chamber oven according to claim 1, wherein
first openings and second openings are provided on the door,
the first door is movably assembled in the first openings of the door, and
the second door is movably assembled in the second openings of the door.

4. The dual-chamber oven according to claim 1, wherein
the first door is provided with an opening or closing assembly, a transmission assembly, and locking assemblies,
the opening or closing assembly is arranged at a front end of the first door,
one end of the transmission assembly abuts against one end of the opening or closing assembly,
the other end of the transmission assembly abuts against one end of each of the locking assemblies, and
the other end of each of the locking assemblies is embedded into the door.

5. The dual-chamber oven according to claim 4, wherein
the door comprises a first frame and a second frame,
the first frame is attached to the second frame, and
a first square through hole and a second square through hole arranged symmetrically are provided on an inner side of the first opening of the first frame.

6. The dual-chamber oven according to claim 5, wherein
each of the locking assemblies comprises a first locking element, a second locking element, a first covering element, and a second covering element,
the first covering element and the second covering element are arranged in an inner chamber of the first door,
the first locking element is arranged in the first covering element, and one end of the first locking element abuts against a limit clamping groove of the first covering element,
the other end of the first locking element penetrates through an opening of the first covering element and extends into the first square through hole of the first frame,
the second locking element is arranged in the second covering element, and one end of the second locking element abuts against a limit clamping groove of the second covering element, and
the other end of the second locking element penetrates through an opening of the second covering element and extends into the second square through hole of the first frame.

7. The dual-chamber oven according to claim 6, wherein
one end of the first locking element is provided with an arc-shaped extension portion, an opposite side of the arc-shaped extension portion is provided with a cylinder, a first limit spring element is nested in the cylinder,
a middle section of the first locking element is provided with a first bulge, one side of the first bulge is provided with a first inclined surface,
the cylinder and the first limit spring element of the first locking element abut against the limit clamping groove of the first covering element, and
the arc-shaped extension portion of the first locking element penetrates through the opening of the first covering element and extends into the first square through hole of the first frame.

8. The dual-chamber oven according to claim 6, wherein
one end of the second locking element is provided with an arc-shaped extension portion, an opposite side of the arc-shaped extension portion is provided with a cylinder, a second limit spring element is nested in the cylinder,
a middle section of the second locking element is provided with a second bulge, one side of the second bulge is provided with a second inclined surface,
the cylinder and the second limit spring element of the second locking element abut against the limit clamping groove of the second covering element, and
the arc-shaped extension portion of the second locking element penetrates through the opening of the second covering element and extends into the second square through hole of the first frame.

9. The dual-chamber oven according to claim 7, wherein
the transmission assembly comprises a receiving component, a transmission rod, a first adapter component, a first reset spring element, a second adapter component, and a second reset spring element,
one end of the receiving component abuts against one end of the transmission rod and one end of the first adapter component,
the other end of the transmission rod abuts against one end of the second adapter component,
the first reset spring element is sleeved at the other end of the first adapter component,
the second reset spring element is sleeved at the other end of the second adapter component,
the other end of the first adapter component abuts against the first inclined surface of the first bulge, and
the other end of the second adapter component abuts against the second inclined surface of the second bulge.

10. The dual-chamber oven according to claim 9, wherein
one end of the transmission rod is provided with a circular structure, the other end of the transmission rod is provided with a connecting piece,
the circular structure at one end of the transmission rod abuts against one end of the receiving component, and
the connecting piece at the other end of the transmission rod abuts against one end of the second adapter component.

11. The dual-chamber oven according to claim 9, wherein
one end of the first adapter component is provided with a cylinder extending outwards,
the other end of the first adapter component is provided with a third inclined surface,
a middle section of the first adapter component is provided with a limit ring,
one end of the first reset spring element is sleeved at one end of the third inclined surface of the first adapter component and limited by the limit ring,
the cylinder of the first adapter component abuts against one end of the receiving component, and
the third inclined surface of the first adapter component abuts against the first inclined surface.

12. The dual-chamber oven according to claim 9, wherein
one end of the second adapter component is provided with a cylinder extending outwards,
the other end of the second adapter component is provided with a fourth inclined surface,
a middle section of the second adapter component is provided with a limit ring,
one end of the second reset spring element is sleeved at one end of the fourth inclined surface of the second adapter component and limited by the limit ring,
the cylinder of the second adapter component abuts against one end of the connecting piece at the other end of the transmission rod, and
the fourth inclined surface of the second adapter component abuts against the second inclined surface.

13. The dual-chamber oven according to claim 12, wherein
one end surface of the receiving component is provided with a recess, a third bulge is arranged on an adjacent side of the recess,
the recess of the receiving component is detachably connected to one end of the opening or closing component, and
the third bulge of the receiving component abuts against the circular structure at one end of the transmission rod and the cylinder of the first adapter component.

14. The dual-chamber oven according to claim 13, wherein
one side of the opening or closing component is provided with an arc bulge, an opposite side of the are bulge is provided with a raised connecting rod, and
the raised connecting rod is embedded into the recess of the receiving component.

15. The dual-chamber oven according to claim 14, wherein
the first door further comprises a front cover plate and a rear cover plate,
and the front cover plate is detachably connected to the rear cover plate.

16. The dual-chamber oven according to claim 15, wherein
a third square through hole and a fourth square through hole arranged symmetrically are provided on a left side and a right side of an upper end of the rear cover plate,
the third square through hole is coaxial with the first square through hole, and
the fourth square through hole is coaxial with the second square through hole.

17. The dual-chamber oven according to claim 16, wherein
the rear cover plate is set to be of a hollow structure, the hollow structure is set as an annular hollow groove, and
the groove is configured to place the first locking element, the second locking element, the first covering element, and the second covering element.

18. The dual-chamber oven according to claim 1, wherein
a limit component is arranged at one end of the oven body and one end of the door, and
the limit component is configured to limit an opening or closing angle of the door when moving radially along the oven body.
